(19) United States
(12) Patent Application Publication
(10) Pub. No.: US 2018/0357032 A1
(43) Pub. Date: Dec. 13, 2018

(54) SYSTEM, APPARATUS, AND METHOD FOR FACILITATING AND PERPETUATING A COLLABORATIVE IDEATION SESSION

(71) Applicant: Nureva, Inc., Calgary (CA)

(72) Inventors: David Gregory Popovich, Ottawa (CA); Mark Andrew Fletcher, Ottawa (CA); Lynette Dawn Loeppky, Calgary (CA); Taco Van Iepern, Calgary (CA); Doug Hill, Calgary (CA)

(21) Appl. No.: 15/735,551

(22) PCT Filed: Jun. 13, 2016
(86) PCT No.: PCT/CA2016/050677

§ 371 Date: Dec. 11, 2017

Related U.S. Application Data
(60) Provisional application No. 62/175,165, filed on Jun. 12, 2015.

(51) Int. Cl. G06F 3/14; H04L 29/06; G06F 3/0488; G06F 3/0484

(52) U.S. Cl. CPC G06F 3/1446; H04L 65/1066; G06F 3/04842; G06F 3/0488; H04L 65/403

(57) ABSTRACT

A system and method for providing a collaborative user interface on an interactive digital workspace, including storing, in one or more storage devices, data corresponding to a plurality of synchronized sessions of the interactive digital workspace; communicating, via one or more network interfaces, the stored data corresponding to one of the plurality of synchronized sessions of the interactive digital workspace to a plurality of display apparatuses; displaying, on the plurality of display apparatuses, the one synchronized session of the interactive digital workspace; receiving user input, via one or more user interface apparatuses, for creating one or more objects on the interactive digital workspace; storing data corresponding to the one or more created objects in association with the displayed session; and updating the displayed session of the interactive digital workspace with the one or more created objects on the plurality of display apparatuses according to the user input, wherein at least one of the plurality of display apparatuses is limited to a horizontal direction for panning the interactive digital workspace through the one or more user interface apparatuses, and at least one of the plurality of display apparatuses and a corresponding one of the one or more user interface apparatuses are embodied in a personal mobile device.

### CROSS-REFERENCE TO RELATED APPLICATIONS

This application is based upon and claims the benefit of priority from the prior U.S. Provisional Application No. 62/175,165, filed on Jun. 12, 2015, the entire contents of which are incorporated herein by reference.

### BACKGROUND OF THE INVENTION

### Field of the Invention

The present invention relates to a system, apparatus, and method for facilitating and perpetuating a digital ideation, collaboration, planning, or creative session with plural participants.

### Description of Related Art

Brainstorming sessions, or ideation sessions, are typically about coming up with multiple ideas; sorting, discussing, and eventually turning an initial dump of ideas into a focused set of ideas that are the most pertinent for the context of the session. Traditional sessions typically employ hard copy sticky notes as a main way to hold an idea (one idea per sticky). This is done to allow multiple people to participate—creation can be an individual activity. The sticky notes are generally adhered to a wall or other accommodating surface and ideas are often moved to various locations on the surface they have been adhered to. Participants sometimes sketch out ideas with pen and paper. These sketches are also often adhered to a wall or other flat surface. Hard copies of photos or other images can also be submitted as representations of ideas in brainstorming and are often also adhered to a wall or flat surface. Hard copy objects—sticky notes, sketches and images—are often grouped together as part of organizing and assessing ideas. Participants write summaries or lists of action items related to the brainstorming on flip charts as part of the ideation process. The downsides to typical brainstorming sessions are the following: notes don't always adhere well after they have been moved a few times; manually moving large clusters of sticky notes to various locations on a wall or other flat surface is time consuming; if the brainstorming involves a large number of participants and takes a long time (many days) the room holding the session needs to be fully booked as the data cannot easily be removed from the room and then reinstated; when the participants run out of space on which to stick notes there are no easy courses of action; notes have to be manually duplicated if required; transcribing notes after a session is very time consuming; limited color of notes; it is difficult to mix with images, other multimedia information, and in some cases digital information; and to participate, one needs to be co-located.

U.S. Patent Application Publication No. 2012/0324372A1 describes systems and methods including providing a data structure stored in computer-readable memory at a first location, monitoring a first work surface provided at the first location, determining that a first physical medium has been manipulated on the first work surface, and, in response, generating a first operation based on a manipulation of the first physical medium, applying the first operation to the data structure.

U.S. Patent Application Publication No. 2012/0331395A2 describes a method for allowing multiple users to interact utilizing a common user interface, the method comprising the steps of: for each user, receiving input data from said user and displaying said input in a user interface portion associated with the user, and, on receiving an instruction from the user, transferring the input data to a common interface portion viewable by the multiple users.

U.S. Patent Application Publication No. 2009/0271708A1 describes a collaboration program that operates on a computer system for storing, sharing and synchronizing data between different users. Centrally stored content data items are organized by associations into one or more folders, with the folders arranged by associations in a multi-level hierarchical structure.

U.S. Pat. No. 7,024,456B1 describes a method permitting collaboration between a plurality of users of incompatible hardware and/or operating system, including steps for selectively generating predetermined objects, text objects, active hyperlink objects, active track objects, and freehand drawing objects, which are displayable at user-selected locations on the White Board screen of one of the users, transmitting all generated ones of the predetermined, the active hyperlink, the text, the active track, and the freehand drawing objects for selective distributions to each of the other users, accumulating the predetermined, the active hyperlink, the text, the active track, and the freehand drawing objects, and filtering the predetermined, the active hyperlink, the text, the active track, and the freehand drawing objects to thereby permit selective transmission of the predetermined, the active hyperlink, the text, the active track, and the freehand drawing objects to respective ones the other users.

U.S. Patent Application Publication No. 2005/0091578A1 describes an electronic version of physical paper sticky notes. The electronic sticky notes may be attached to or embedded in items such as files and folders. The icons representing the items may include indications as to whether an electronic sticky note is attached thereto. The electronic sticky notes may be seamlessly moved between various attachment states and between various locations on a computer screen.

U.S. Pat. No. 7,707,249B2 describes systems and methods that provide a client-server infrastructure capable of supporting a variety of asynchronous and synchronous collaboration activities in a so-called collaboration place. Some of these activities include chatting, viewing and/or editing one or more data files, and sharing one or more applications, data files, and/or displays.

U.S. Patent Application Publication No. 2008/0177771A1 describe a method and system of conducting multi-location collaboration. The method comprises the steps of establishing a collaboration session among the multiple remote users, each of the users having a respective white board; and during the collaboration session, said multiple users exchanging audio, video, text and graphics among the multiple users via the white boards, said collaboration session including branching points and collaboration output between the branching points.

### SUMMARY OF THE INVENTION

It is an advantage of the present invention to overcome the problems of the related art and to provide a modular, ultra-wide interactive digital workspace (or surface) utilizing a server and/or cloud-based implementation such that team members can participate in a session through direct interaction with the interactive surface or a personal device either in person or remotely.

### BRIEF DESCRIPTION OF THE DRAWINGS

Exemplary embodiments of the presently preferred features of the present invention will now be described with reference to the accompanying drawings.

FIG. 1 is a block diagram of a system for providing a collaborative and interactive idea exchange and recording session according to an embodiment of the invention.

FIGS. 2A, 2B, 2C, and 2D are diagrams illustrating a note recording session in accordance with an exemplary embodiment of the invention.

FIGS. 3A, 3B, 3C, and 3D are diagrams illustrating features of the note recording system according to an exemplary embodiment of the invention.

FIGS. 4A, 4B, and 4C are diagrams illustrating an interactive screen on a mobile device for participating in a note recording session according to an embodiment of the invention.

FIGS. 5A and 5B are diagrams illustrating a detailed “calm” background for a note recording session according to an embodiment of the invention.

### DETAILED DESCRIPTION OF THE PRESENTLY PREFERRED EXEMPLARY EMBODIMENTS

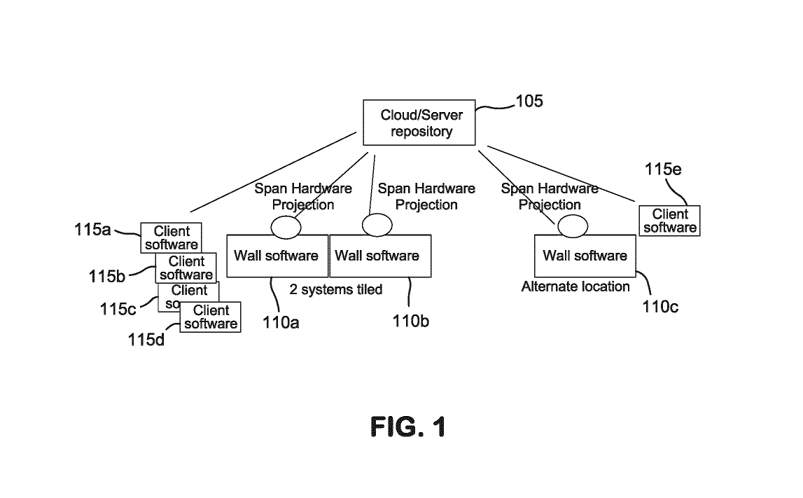

With reference to FIG. 1, the ideation system in accordance with an embodiment of the invention includes a cloud (or local/remote server) repository 105, wall projection systems 110a-c, and client devices 115a-e. Each of cloud (or local/remote server) repository 105, wall projection systems 110a-c, and client devices may be implemented with a processing device, including hardware (such as a CPU, memory, storage and peripheral hardware such as co-processing) and/or software. For example, cloud or server repository 105 may include one or more processors, memory, and storage devices for recording data corresponding to objects created and placed on the interactive surface according to the invention as described below. And cloud or server repository 105 may communicate with wall projection systems 110a-c and client devices 115a-e through one or more network and/or data connections. Client devices 115a-e may include personal computers, terminals, laptops, mobile telephones, tablet computers, or any other computing device easily accessible by individual team members in an ideation session. As shown in FIG. 1, client devices 115a-d may be co-located with wall projection systems 110a-b in a main location of a session. And client device 115e may be at an alternative location with, or separate from, wall projection system 110c. According to an alternative embodiment, wall projection systems 110a-c may be replaced with any display system, ideally having no bezel protrusions, so that items can be interacted with and brought across a tiled set of displays composing an interactive surface—for example, a LCD/plasma display having a flat glass interaction layer, projection systems utilizing interactive whiteboards, OLED displays or a tile of display panels that are unified with a touch system. The wall projection systems 110a-c may each execute panning of the software that allows information from the cloud or server repository 105 to be viewed by people in a given location. A shared digital workspace—or a perpetual interactive surface—that is maintained in the cloud or server repository 105 may be at a fixed height (geared for data to preferably be displayed from 42″-46″ in height), without any limitation on its width. As an example, a shared digital workspace may be 60 feet in width of digital projection. The terms shared digital workspace, and workspace may be used interchangeably hereinafter to refer to the interactive surface provided on a common synchronized session that is displayed on and interacted with by participants at wall projection systems 110a-c and client devices 115a-e.

In accordance with an exemplary embodiment of the invention, the system allows panning of the shared digital workspace horizontally on wall projection systems 110a-c, but not vertically, nor does it allow zooming in and out on these systems. Advantageously, the limited one-dimensional movement of the shared digital workspace, prevents users from becoming disoriented from too many axes of movement—i.e., zooming in and out together with panning up and down)—especially when such users are not controlling the movement.

The amount of shared digital space to project may be based on the resolution of the projection system. The aspect ratio of the system is taken into consideration and the shared digital workspace is fit to the vertical resolution of the projector. In the ultra-wide projection format (16:6), there is approximately 10 feet of horizontal digital space at a 46″ height. This means that 10 feet of the shared digital workspace can be viewed at one time with one wall projection system 110a, b, or c. In accordance with an embodiment of the invention, the shared digital workspace may also be displayed using any interactive display system, including but not limited to touch screens, monitors, table displays, and the like.

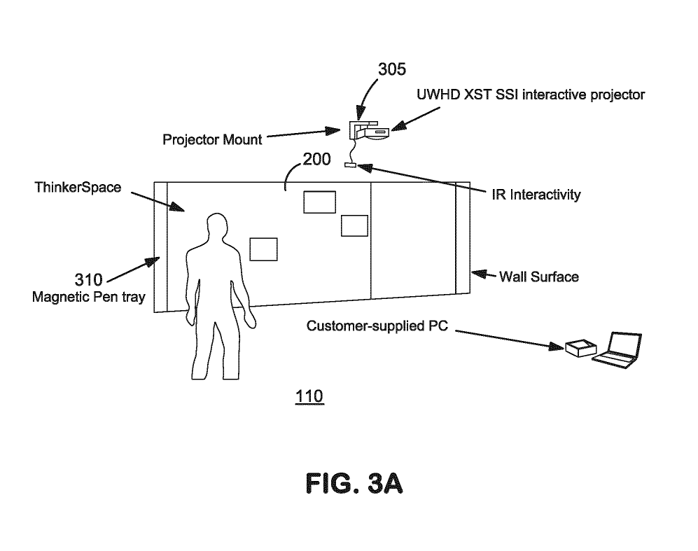

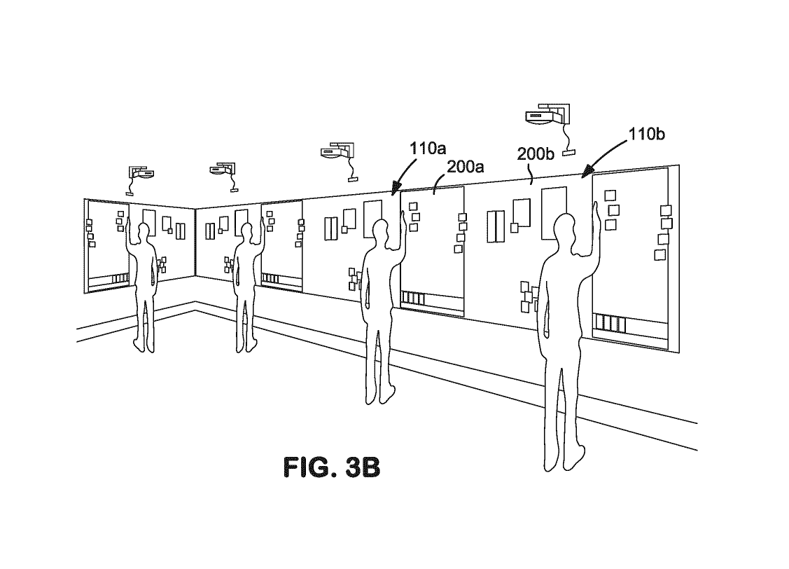

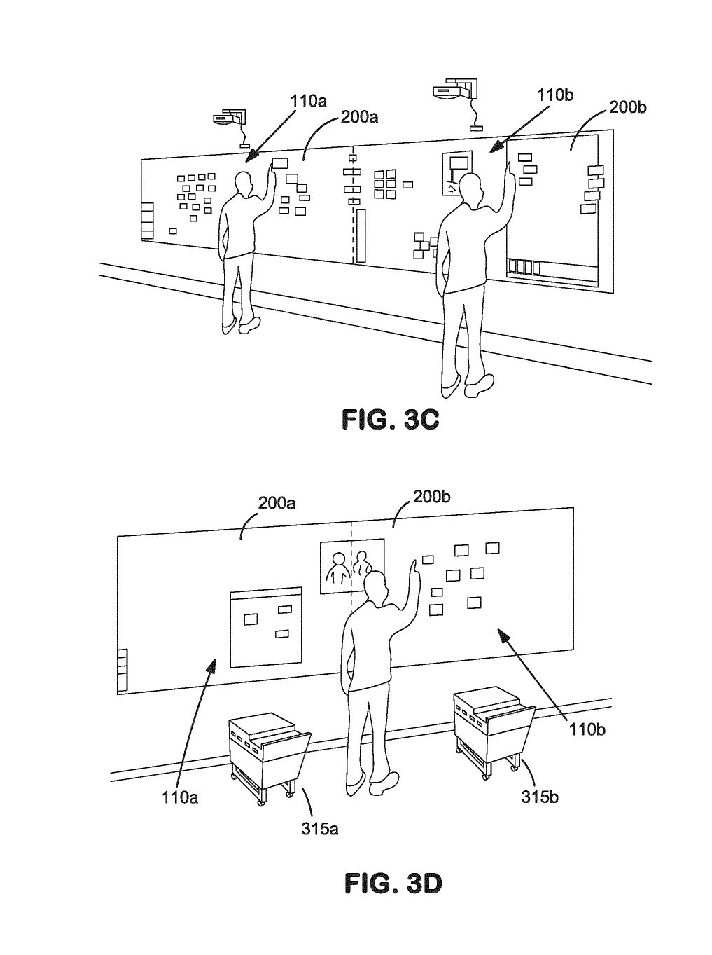

If more than one wall projection system is used in a tiled manner, for example at a location for wall projection systems 110a and 110b shown in FIG. 1 (also as shown in FIGS. 3B-3D) the cloud or server repository 105 pushes the appropriate data to each display—for example, pushing the first 10 feet to the first system 110a and the second 10 feet to the second system 110b. Either through system intelligence (auto-detection) or by user input, any of the wall projection systems 110a-c may enter a tiled session with one another. The tiled session apparatuses are then synchronized through cloud or server repository 105—e.g., for panning, dragging items across tile seams, and drawing across tile seams. It is also important to note that there are some special requirements for a tile system:
1. Interactivity from one system to another, where each system has a computer and an interactive display, must be contained to the projected pixels. If display A is touched and a drag event moves from A across to display B, screen A must drop the touch as soon as it leaves its border and screen B must pick it up as the touch transitions across into its border. In the case where one computer has multiple interactive displays, the interaction must afford the ability to unify the interaction as if it were one large digitizer so that objects are not dropped as they transition from one display to the next.
2. For some operating systems, such as but not limited to Windows 8, side bars and other gesture-based tools must be turned off or suspended or they will trigger as a user interacts continuously from one display to the other. They must also be turned off or suspended to allow touch interaction to the borders of the system. This can also be achieved if the touch events are first filtered with a driver and then sent to the operating system. In this case, edge events that would normally trigger sidebar or charm bar events are not sent to windows, but instead to the specific software as an input instead of a mouse event to the system.

For the example shown in FIG. 1, the entire shared digital workspace, may be displayed on wall projection system 110c and client devices 115a-e. As described above, since the shared digital workspace does not visually extend vertically beyond the projection system, participants at the wall projection system 110c can access the entire shared digital workspace through horizontal panning. And according to an embodiment of the invention, since individual participants at client devices 115a-e are likely not affected by disorientation of shared digital workspace movement on such devices, they may be provided with full control of the display of the shared digital workspace—i.e., multi-directional scrolling (panning) and zooming of the shared digital workspace on client devices 115a-e.

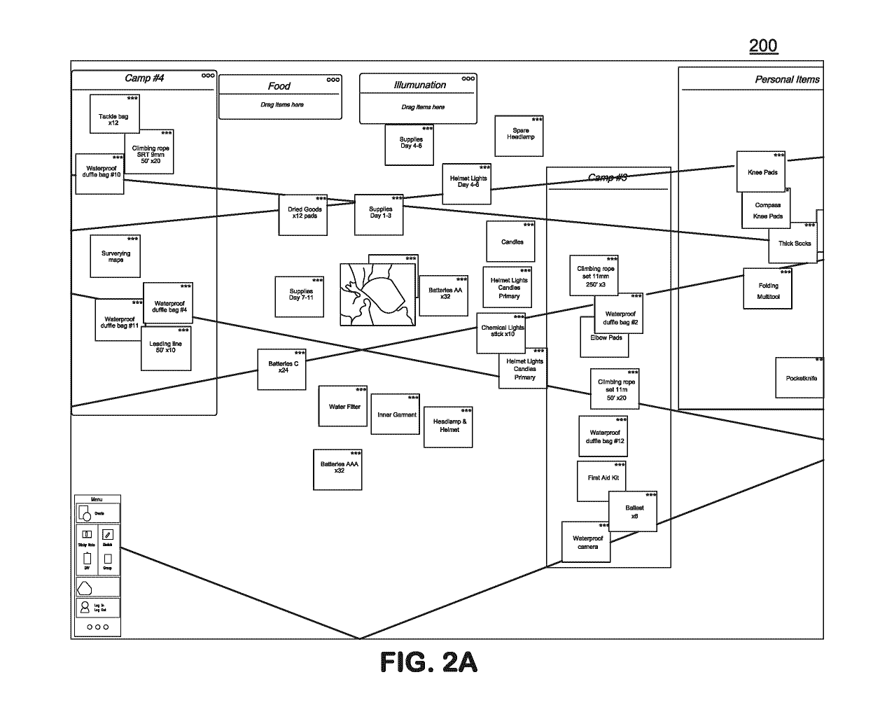

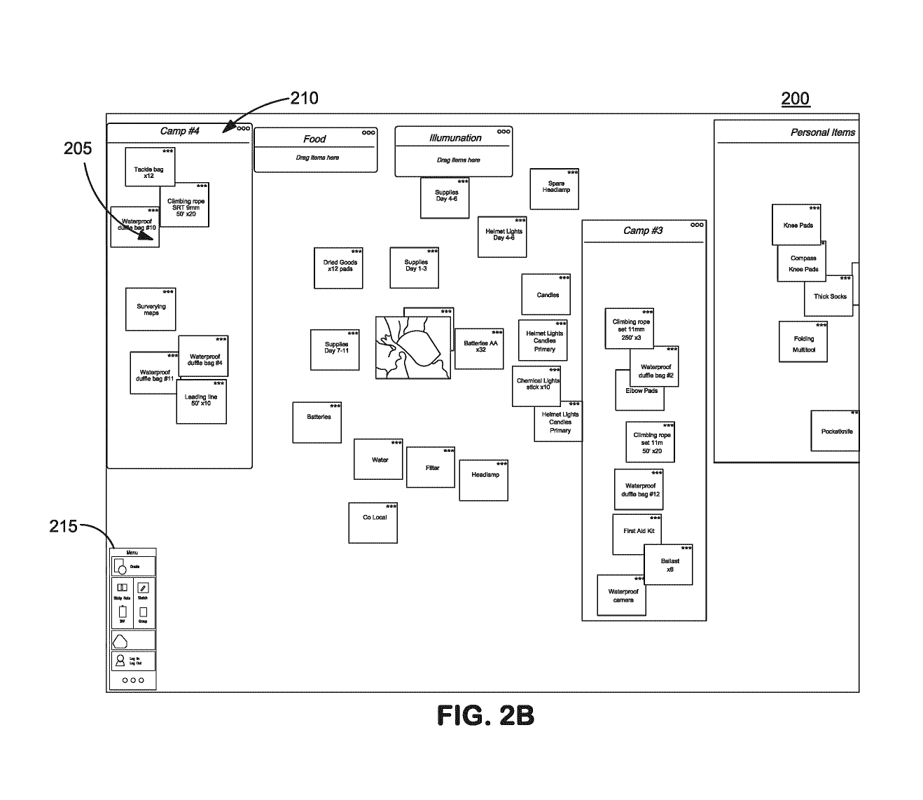

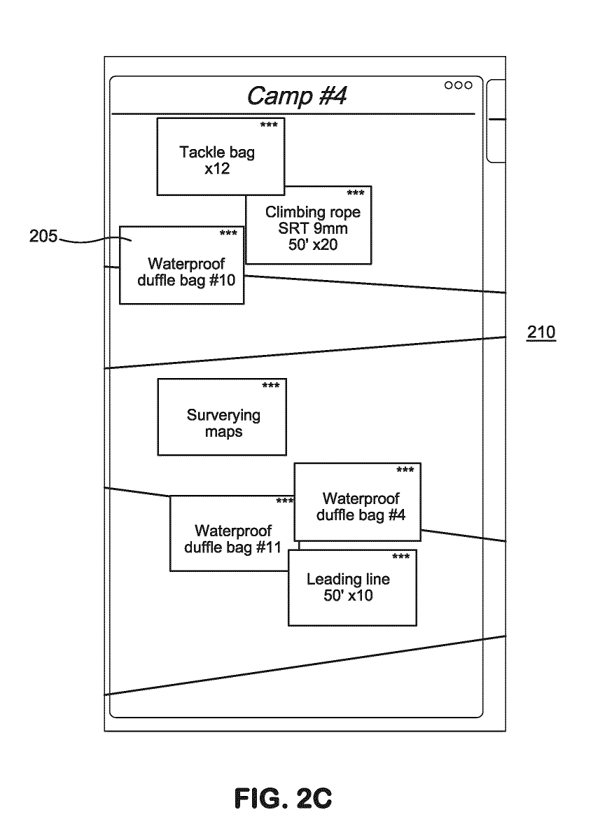

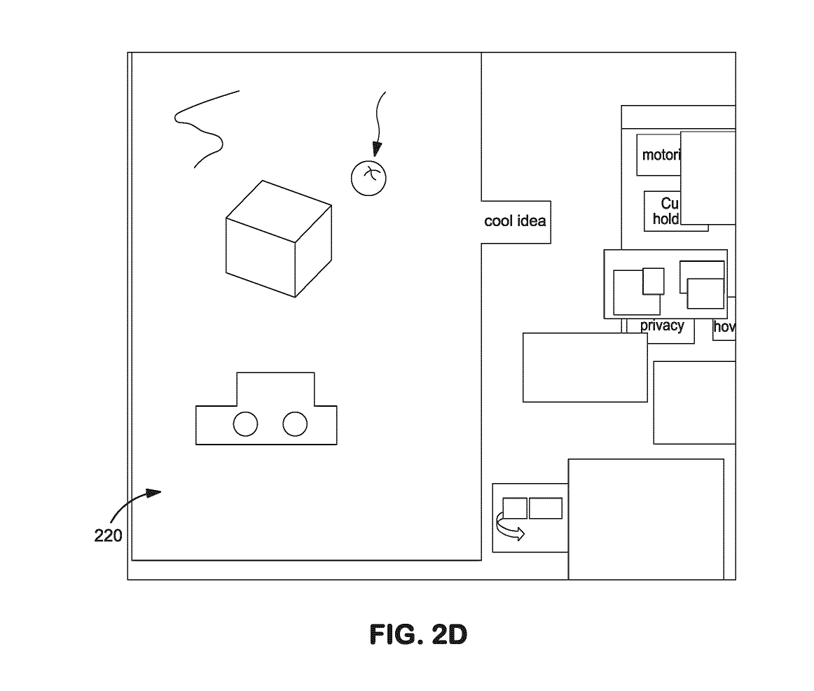

FIGS. 2A-2D are diagrams illustrating a shared digital workspace 200, or interactive surface, according to an embodiment of the invention. As shown in FIGS. 2A-2D, a plurality of shared digital objects such as but not limited to virtual “stickies”—digital sticky notes—205 may be displayed, each identifying an idea or concept input by a participant. The shared digital workspace supports creation and movement of the digital stickies, editing with a virtual popup keyboard (multiple users can each have a context-based keyboard, not shown), drawing and note-taking on whiteboards or sketches 220 (as shown in FIG. 2D), grouping via a grouping container 210 (as shown in FIGS. 2A-B and in detail in FIG. 2C), input of images as well as panning though the shared digital workspace. As shown in FIGS. 2A and 2B, interactive function elements 215 may be included on the bottom left of the shared digital workspace for login/logout, shared digital work space selection and manual section assignment for synchronized tiling, and the initiation of container creation on the shared digital objects such as but not limited to sticky notes, sketches, flip charts and groups, with a header to indicate the current shared digital workspace. This section 215 can be minimized by selecting the three dots, or maximized when at min. In accordance with an embodiment of the invention, shared digital object (or item) types that can be created by a participant may include sticky notes, sketches, groups, images, flip charts, ink, etc., whereas containers may be characterized as a window, a header, a group, a directory, and the like. In accordance with an embodiment of the present invention, groups of objects may also represent a container, therefore containers may also include images, groups, sketches, and flip charts.

FIGS. 3A-3D illustrate a wall projection system 110 in accordance with exemplary embodiments of the invention. The system 110 may include a projector mount (wall mount) 305, 2 stylus and an optional surface 310 that can be adhered to a wall. The size of the projection may be 46″ in height which yields roughly a 10 foot horizontal projected space. Projector resolution may be but not limited to 1920×720. The interactive system may be implemented with an optical CMOS-based capture system that tracks IR events at the wall. The interactive system may also deploy a shutter so that an automatic calibration can be done. This is achieved by viewing in visible light a pattern on the wall and touch locations for calibration through image processing. When calibration is finished, the camera triggers the shutter back to a notch filter to only see near IR events.

According to an embodiment of the invention, multiple systems 110a and 110b may be used to project respective “tiled” portions (200a and 200b) of a larger interactive surface, as shown in FIGS. 3B-3D. The systems 110a and 110b may cooperate, directly or through cloud or server repository 105, to align the displayed portions (200a and 200b) and synchronize elements that are moved between the tiled portions (200a and 200b). The wall projection system 110 may also be embodied in a mobile cart (315a and 315b) with a projector, computer, control system, and potentially a warping box all integrated within, as shown in FIG. 3D. The cart may include a control system as the normal use case may be two or more systems together. The cart also comes with a warping box to adjust the projected image for each cart to make the tiled shared digital workspaces appear seamless. A warping box might be used for the permanent wall-mounted system to allow easier display adjustment, but a permanent system can have the projected images abutted manually (moving the projector in the mount) instead of a warping box. A typical wall-mounted system may be 10 feet, where a mobile unit (cart) may create a 6 foot horizontal shared digital workspace—with two of them yielding 12 feet in horizontal virtual space.

The control system allows each mobile cart to communicate with others so that on off functions can be synchronized, location of carts can be understood for multiple tiled systems, and for the ability to automatically blank adjacent systems when performing an auto calibration for touch.

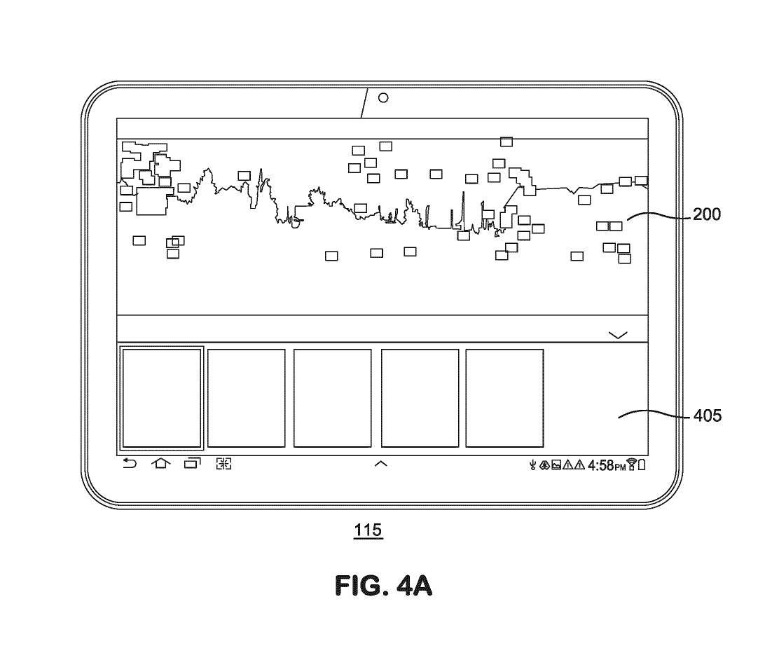

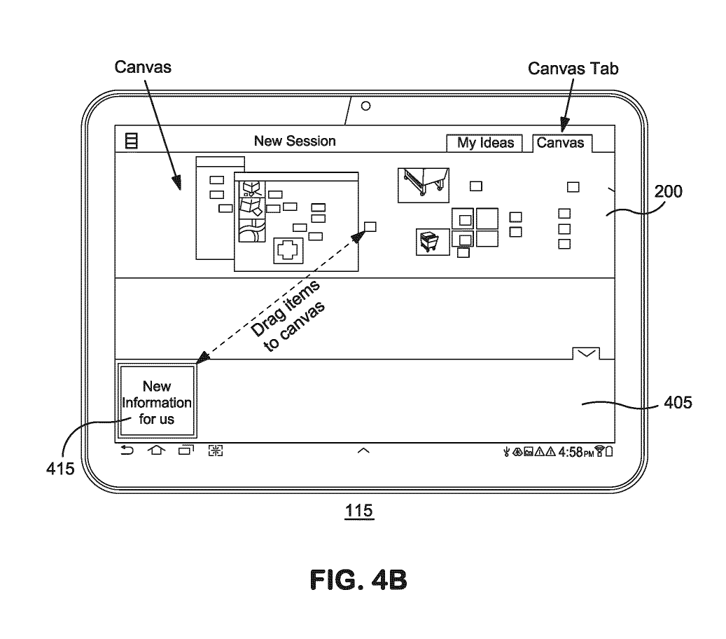

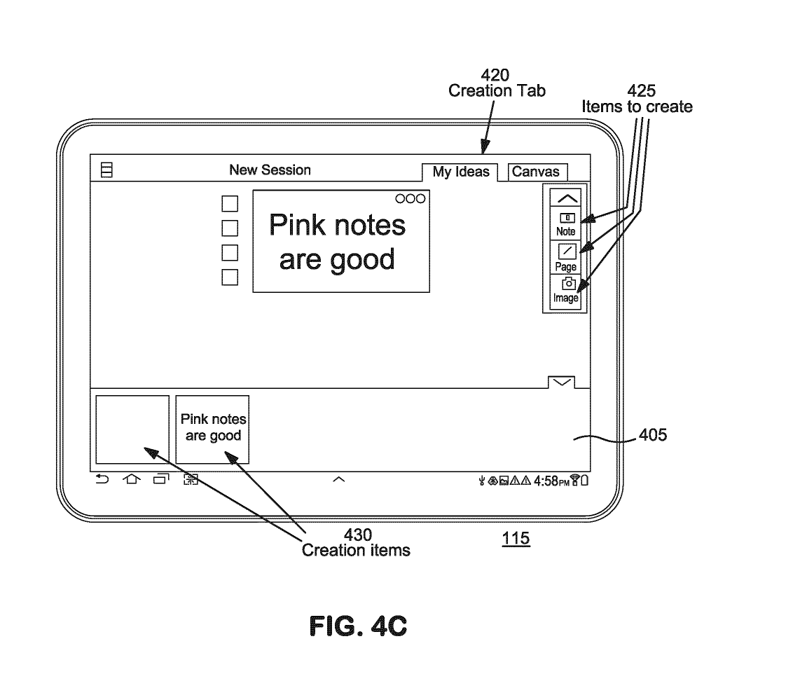

FIGS. 4A-4C illustrate a display of the shared digital workspace, on a client device 115 in accordance with an embodiment of the invention. A participant can create information and seamlessly place it to a location of their choice in the shared digital workspace using the client device 115. Clients connect to the session through cloud or server repository 105 and can see all of the digital space or a portion of it or a synchronized view of what is on the shared digital workspace. Digital objects can be created or taken from the client and placed on the shared digital workspace, thus becoming shared with all participants of the shared digital workspace. The client device 115 may be a mobile device executing client software providing an interface for but not limited to the creation of notes via keyboard or drawing input. For example, as shown in FIGS. 4A and 4B, a bottom portion of the display on client device 115 may include a section (“idea tray” or digital object container) 405 for pending notes and objects that are created or stored locally on the client device 115. And a top portion of the display on client device 115 may show the shared digital workspace 200, which is shown on all other devices connected to the synchronized session. Digital objects do not have to be placed on the shared digital workspace immediately after creation. They can be placed in the idea tray 405, and then placed in the shared digital workspace 200 when the participant is ready. This allows participants to work faster in documenting their thoughts and then share the digital objects when they are ready. As shown in FIG. 4B, an object 415, such as a note, may be dragged from the idea tray 405—which is local to each participant—to the shared digital workspace 200—which is available to all participants simultaneously—when the participant is ready to move the digital object onto the shared digital workspace 200. After the digital object is dragged onto the shared digital workspace, it is displayed on all other devices connected to the synchronized session at the location on the shared digital workspace that the participant dragged it to on the client device 115.

According to an embodiment of the invention, the client device may include a creation mode, which may be accessed via a tab 420 as an alternative to the shared digital workspace view, as shown in FIG. 4C. As described above, the shared digital workspaces can be panned in all directions, or also zoomed in and out on the client (mobile) device 115. This is allowed as it is a personal view and the participant who is manipulating the shared digital workspace is also the viewer; unlike the wall-projected image where the person manipulating the shared digital workspace is not the only person viewing the shared digital workspace. Participants viewing the shared digital workspace may become disoriented if remote participants are controlling the movement of the shared digital workspace from their own devices. Again, the creation mode may be a tab within the client software, as shown in FIG. 4C. Participants can tab between the shared digital workspace shown in FIG. 4B, where they can review the shared digital workspace and also place created items (shared digital objects such as but not limited to notes) from the idea tray, and the idea tab shown in FIG. 4C where they have the ability to create items of different types 425. The items 430 created in the creation mode are automatically placed in the idea tray 405 so they are ready to be placed on the shared digital workspace 200. The participant may then tab to the shared digital workspace shown in FIG. 4B to drag the created items from the idea tray onto the wall.

In accordance with an embodiment of the invention, the creation mode may also be automatically triggered so that participants do not have to use tabs. A set of tools allows the participant to select the shared digital object type that they wish to create and the system automatically enters creation mode for the object. When finished, participants can drag the new objects from the idea tray onto the shared digital workspace.

One aspect of the invention is to create a focus on the data that is created in an immersive projection environment by making the background calm. Calm is created by the absence of a bright background—in other words a background that is created by not projecting white light (in contrast with the conventional white background of common projected presentations). This not only removes visual noise from a large projected area but only illuminates areas of importance. This is important as participants of a large projected system could tire faster with, say, a white projected background (less light=less eye strain over time). When this is done, the data that is intended to be in the shared digital workspace appears to float on top of the wall or surface that it is projected on—also mimicking what hard copy sticky notes look like when they are adhered to a wall.

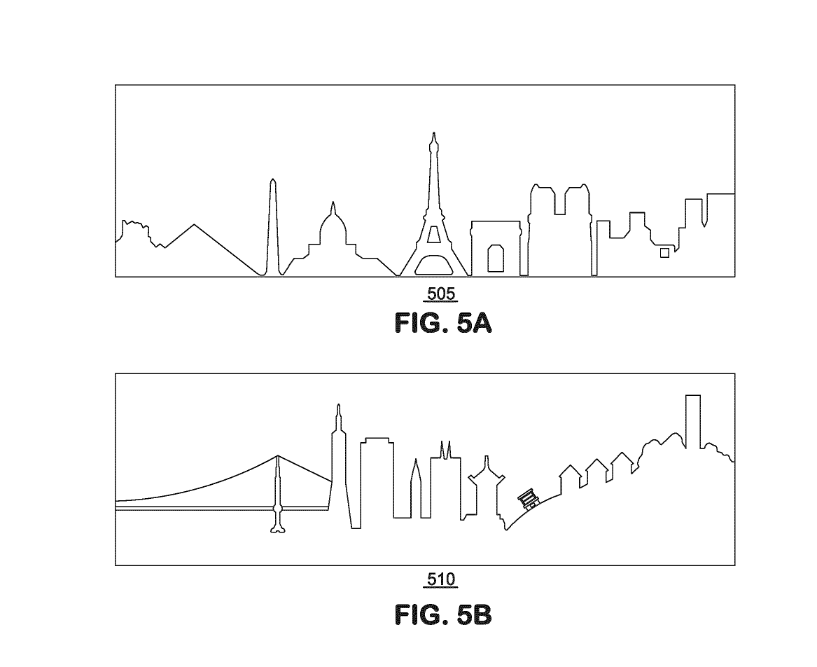

A second aspect to the calm background is the ability to have a better degree of spatial awareness. By using a watermark (or background) that is very subtle, but still visible, such as the ones 505 and 510 illustrated in FIGS. 5A and 5B, users of the system are enabled to remember and relate where individual pieces of data reside by reference to details in the watermark. For example, the watermark may include easily identifiable details relevant to the locality of the session or the participants of the session. And at the same time, the watermark does not distract participants from the displayed digital shared object information. Particularly for large shared digital workspaces, participants might be viewing 10′ or more of scrollable shared digital workspace. With the spatial awareness watermark, it is much easier to remember where pieces of data are, or how far one needs to scroll based on the watermark. (Not dissimilar to remembering where data is in a book by the thickness of pages.)

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. For example, while the invention has been described in terms of brainstorming and ideation, the invention can be utilized to support group-work for storyboarding, process mapping, requirements management, cost reduction identification, war room style processes or any other type of visual collaboration traditionally done on large areas. The scope of the following claims is to be accorded the broadest interpretation so as to encompass all such modifications and equivalent structures and functions.

All U.S. and foreign patents and patent applications discussed above are hereby incorporated by reference into the Detailed Description of the Preferred Embodiments.

What is claimed is:

1. A program embodied in a non-transitory computer readable medium for providing a collaborative user interface on an interactive digital workspace, said program comprising instructions to perform:
storing, in one or more storage devices, data corresponding to one or more synchronized sessions of the interactive digital workspace;
communicating, via one or more network interfaces, the stored data corresponding to one of the one or more synchronized sessions of the interactive digital workspace to a plurality of display apparatuses;
displaying, on the plurality of display apparatuses, the one synchronized session of the interactive digital workspace;
receiving user input, via one or more user interface apparatuses, for creating one or more objects on the interactive digital workspace;
storing data corresponding to the created one or more objects in association with the displayed session; and
updating the displayed session of the interactive digital workspace with the one or more created objects on the plurality of display apparatuses according to the user input, wherein
at least one of the plurality of display apparatuses is limited to a horizontal direction for panning the interactive digital workspace through the one or more user interface apparatuses, and
at least one of the plurality of display apparatuses and a corresponding one of the one or more user interface apparatuses are embodied in a personal mobile device.

2. The program of claim 1, further comprising instructions to perform:
storing and displaying a background including plural detail features on the interactive digital workspace for the displayed session.

3. The program of claim 1, wherein at least two of the plurality of display apparatuses are wall projection apparatuses each displaying a different portion of the interactive digital workspace adjacent to each other.

4. The program of claim 1, further comprising instructions to perform:
displaying, on the personal mobile device, the synchronized session of the interactive digital workspace on a first portion of a display and one or more locally created objects on a second portion of the display, and
when the one or more locally-created objects is moved from the second portion to the first portion via the user input, transmitting data corresponding to the one or more locally-created objects to the one or more data storage devices for synchronized display on the plurality of display apparatuses.

5. A method for providing a collaborative user interface on an interactive digital workspace, the method comprising:
storing, in one or more storage devices, data corresponding to a plurality of synchronized sessions of the interactive digital workspace;
communicating, via one or more network interfaces, the stored data corresponding to one of the plurality of synchronized sessions of the interactive digital workspace to a plurality of display apparatuses;
displaying, on the plurality of display apparatuses, the one synchronized session of the interactive digital workspace;
receiving user input, via one or more user interface apparatuses, for creating one or more objects on the interactive digital workspace;
storing data corresponding to the one or more created objects in association with the displayed session; and
updating the displayed session of the interactive digital workspace with the one or more created objects on the plurality of display apparatuses according to the user input, wherein
at least one of the plurality of display apparatuses is limited to a horizontal direction for panning the interactive digital workspace through the one or more user interface apparatuses, and
at least one of the plurality of display apparatuses and a corresponding one of the one or more user interface apparatuses are embodied in a personal mobile device.

6. The method of claim 5, further comprising:
storing and displaying a background including plural detail features on the interactive digital workspace for the displayed session.

7. The method of claim 5, wherein at least two of the plurality of display apparatuses are wall projection apparatuses each displaying a different portion of the interactive digital workspace adjacent to each other.

8. The method of claim 7, further comprising:
displaying, on the personal mobile device, the interactive digital workspace on a first portion of a display and one or more locally created objects on a second portion of the display, and
when the one or more locally-created objects is moved from the second portion to the first portion via the user input, transmitting data corresponding to the one or more locally-created objects to the one or more data storage devices for synchronized display on the plurality of display apparatuses.

9. A system for providing a collaborative user interface on an interactive digital workspace, comprising:
a plurality of display apparatuses;
one or more user interface apparatuses;
one or more storage devices;
one or more network interfaces;
memory; and
one or more processors configured to execute one or more programs stored on the memory, said programs including:
instructions for storing, in the one or more storage devices, data corresponding to a plurality of synchronized sessions of the interactive digital workspace;
instructions for communicating, via the one or more network interfaces, the stored data corresponding to one of the plurality of synchronized sessions of the interactive digital workspace to the plurality of display apparatuses;
instructions for displaying, on the plurality of display apparatuses, the one synchronized session of the interactive digital workspace;
instructions for receiving user input, via the one or more user interface apparatuses, for creating one or more objects on the interactive digital workspace;
instructions storing data corresponding to the one or more created objects in association with the displayed session;
instructions for updating the displayed session of the interactive digital workspace with the one or more created objects on the plurality of display apparatuses according to the user input, wherein
at least one of the plurality of display apparatuses is limited to a horizontal direction for panning the interactive digital workspace through the one or more user interface apparatuses, and
at least one of the plurality of display apparatuses and a corresponding one of the one or more user interface apparatuses are embodied in a personal mobile device.

10. The system of claim 9, wherein said programs further comprise instructions for storing and displaying a background including plural detail features on the interactive digital workspace for the displayed session.

11. The system of claim 9, wherein at least two of the plurality of display apparatuses are wall projection apparatuses each displaying a different portion of the interactive digital workspace adjacent to each other.

12. The system of claim 9, wherein said programs further comprise:
instructions for displaying, on the personal mobile device, the interactive digital workspace on a first portion of a display and one or more locally created objects on a second portion of the display, and
instructions for, when the one or more locally-created objects is moved from the second portion to the first portion via the user input, transmitting data corresponding to the one or more locally-created objects to the one or more data storage devices for synchronized display on the plurality of display apparatuses.
